(19) United States
(12) Patent Application Publication
(10) Pub. No.: US 2002/0156902 A1
(43) Pub. Date: Oct. 24, 2002

(54) Language and culture interface protocol

(76) Inventor: John Christopher Crandall, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/834,338

(22) Filed: Apr. 13, 2001

(51) Int. Cl. G06F 15/16

(52) U.S. Cl. 709/228

(57) ABSTRACT

The invention discloses a cultural interface protocol application. In the preferred embodiment, the cultural interface protocol application is used on a computer system for preferably providing a culture-specific experience with a client application. The cultural interface protocol preferably comprises a user profile that defines particular cultural attributes and that is stored in the computer's memory. A protocol interface within the protocol application facilitates communication between the cultural interface protocol application and any compatible host or client application. Certain ones of the cultural attributes in the user profile are determined by an algorithm with the protocol application to communicate to the host or client application. The client application is preferably configured specifically according to the particular cultural attributes communicated from the cultural interface protocol application. Thus, the host or client application is preferably customized according to the culture of the protocol application user's actual or desired cultural makeup.

### BACKGROUND

Computers have become an indispensable tool for people to run and manage the modern world. Computer and Internet applications routinely reach across oceans and continents without regard for borders or national identities. While the computers themselves typically communicate and operate together in relatively universal, if not type-specific, machine languages, the individuals using the computers generally speak any number of the different languages of the world. These languages may or may not be the same as the language of the computer programmer. Thus, an English version of Microsoft Word (TM) or Amazon.com (TM) may not typically be useful to a person living in Ghuangzho, China who speaks only Cantonese or Mandarin, or to a person living in Yaroslavl, Russia, who speaks only Russian. Not only would the language be incompatible, but a computer may also need a completely new set of graphics drivers to render the Chinese ideographs or Cyrillic alphabet.

Moreover, a generic German version of Microsoft Word (TM) or Amazon.com (TM) may convey different, if not improper or incorrect, messages between German-speaking people living in Germany, Austria, and Switzerland. In addition to the interpretational differences caused by different regional dialects, different cultures may perceive graphical images or colors in many different ways. For example, in China, green, purple, and/or black may typically have a negative connotation associated therewith. Similarly, a cross may be perceived negatively by different cultures. For example, the International Federation of Red Cross and Red Crescent Societies typically uses a red cross symbol in the West to represent the participating organization. However, in the Middle East and mostly-Islamic countries a red crescent is used because of the connotation associated with a cross in those countries.

To increase the reach and marketability of computer software and the Internet, software manufacturers and Internet companies typically have begun providing software and websites in many different languages. Many of these language solutions are based on local settings in the operating system of the user's computer. When a software application is loaded or a website visited, the local setting in the operating system may be used to select the language version presented in the application or on the website. Additional solutions are generally offered directly to the user when loading software or accessing compatible websites. In software applications, a properties box may be displayed to the user to choose the desired language for the application. Similarly, websites many times display flag icons or option hyperlinks representing alternate language versions.

Some software applications may also generally use regional settings to configure the presentation of times, currency, numbers, etc. For example, some operating systems allow a user to select the region in which the computer is located. When certain applications are run on the computer, the applications may use the regional settings of the operating system to display the proper time format or even the proper currency. Because these regional settings may generally customize down to the currency, the optional choices allow designation of a particular country or region. However, in these types of applications, language, colors, and symbols are typically not variable using the selected regional setting.

The current methods for extending the reach and usability of computers and the Internet only typically address languages. While many websites and computer applications offer different and various language-specific versions, there are no universally accessible websites or software applications which offer optional culture-specific versions. One problem with the lack of culture-specific applications is the potential for offending different users. The problem may not generally have a severe impact on widely-used software applications, but may create a large negative impact on commercial websites in which potential customers are offended by a seemingly innocuous symbol or color.

A further problem with the current methods for addressing the language variations is that it requires the interaction of the user. The user must set the language profile or must choose the optional language. This may, in and of itself, create a problem if the user cannot understand the directions necessary to change to language. Furthermore, a user may not even know that there is a way to change the language because of a lack of familiarity with computers.

### SUMMARY OF THE INVENTION

In consideration of the problems of the current methods, it would be desirable to have a dynamic language and culture interface protocol that automatically communicates the appropriate language and culture preferences to a software application or website for presenting a culture-specific interface to the user.

The present invention is directed to a system and method for providing a dynamic language and culture interface protocol to facilitate the presentation of a culture-specific interface to a user. In the preferred embodiment, a cultural interface protocol application that can be used on a computer system is disclosed comprising a user profile that defines particular cultural attributes and that is stored in the computer's memory. A protocol interface within the protocol application allows the application to communicate and interface with any compatible host or client application. An algorithm within the application determines certain ones of the cultural attributes in the user profile to communicate to the host or client application. Once the appropriate cultural attributes have been communicated to the client application, it is configured specifically according to those particular cultural attributes. Thus, the host or client application may be customized according to the culture of the protocol application user's specific cultural makeup.

### BRIEF DESCRIPTION OF THE DRAWING

FIG. 1A is a screen shot from a prior art operating system dialog box allowing for user choices for basic regional settings;

FIG. 1B is a screen shot from a prior art computer application dialog box allowing a user to choose the basic language for the application interface;

FIG. 2A is a screen shot from a prior art Internet website providing an optional language hyperlink;

FIG. 2B is a screen shot from the prior art Internet website depicted in FIG. 2A presented in the optional language;

FIG. 3 is a block diagram illustrating a preferred embodiment of the present invention configured to provide a dynamic culture-specific Internet web interface; and

FIG. 4 is a flow chart describing the steps of an alternative embodiment of the present invention for providing a culture-specific graphical user interface.

### DETAILED DESCRIPTION

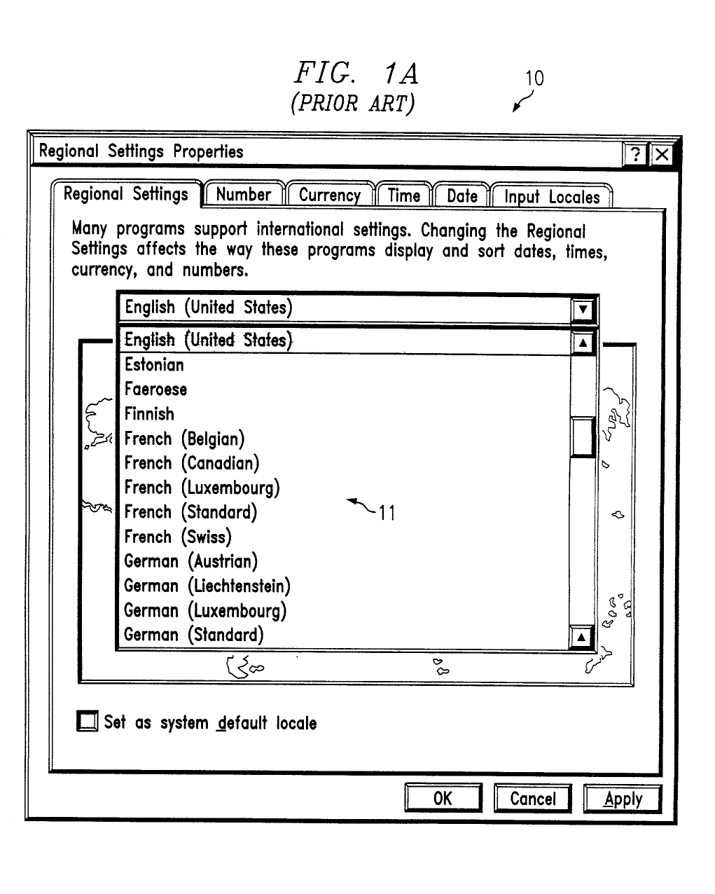

The current methods for varying the presentation of client applications, such as software applications or Internet websites, generally allow a user to choose a single language or to set certain regional preferences for how numbers, dates, and/or times are presented. FIG. 1A is a screen shot resulting from one such prior art method included in an operating system application. Regional setting dialog box 10 presents list 11 of different languages and the originating countries for a user to choose. By choosing a particular language/region from list 11, other compatible applications running on the computer will read the selected regional settings and display items such as dates, times, currencies, etc., in the manner consistent with the user-selected language/region choice. For example, in many parts of the world, the date is displayed day, month, year (e.g., 28/01/2001 for Jan. 28, 2001). Similarly, in some countries, decimal/periods are replaced with commas in numbers (e.g., 100,00 instead of 100.00). Other software applications which read the regional settings information will, therefore, reconfigure the way in which the numbers and dates are presented to the user.

FIG. 1B is another screen shot resulting from a prior art method in computer applications or programs for providing multiple language choices for a user to choose the basic language of an application's interface. Dialog box 12 presents list 13 of the different languages available for the particular computer application. When the user chooses a language from list 13, the program continues setting up or installing itself onto the host computer using the chosen language. All subsequent interfaces between the user and the application will then typically be with the chosen language.

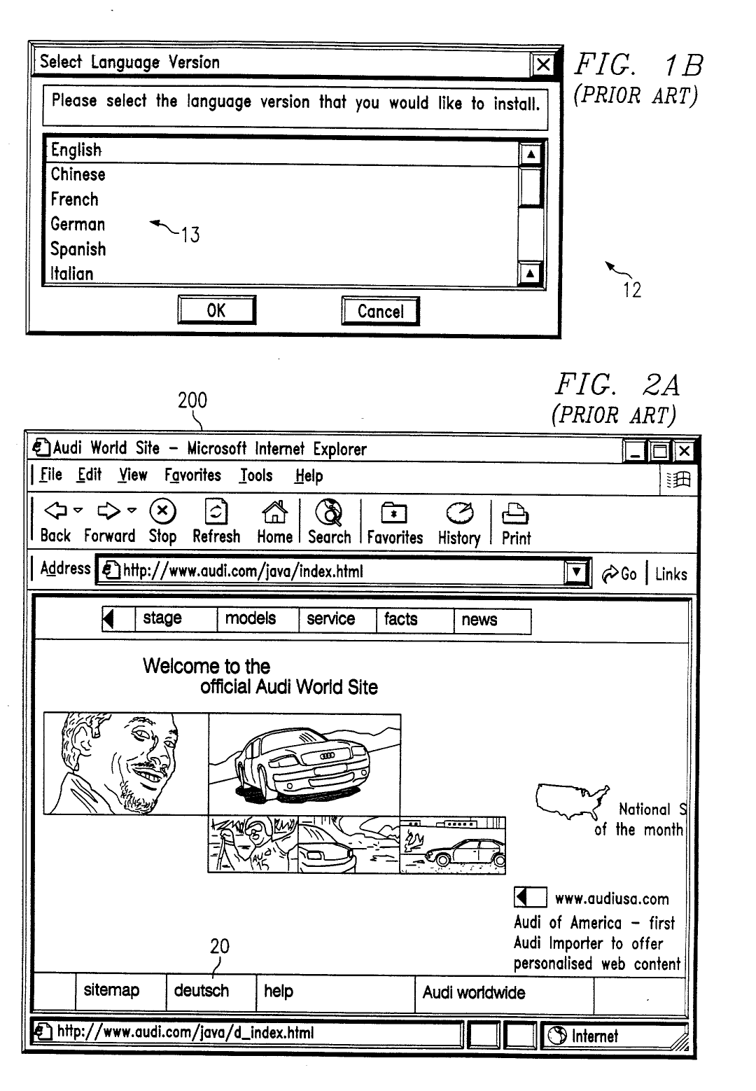

FIGS. 2A and 2B are screen shots resulting from the prior art methods for allowing optional languages on Internet websites. Web page 200 displays normal graphics and textual information to a user. One of the hyperlinked buttons displayed is language button 20. Language button 20 offers the user the option to view web page 200 in German. The label on language button 20 is written in German in order to provide a familiar key for German users viewing web page 200.

Upon actuation of language button 20, web page 200 is re-configured using the German-language version as shown in FIG. 2B. As will be appreciated from FIG. 2B, web page 201 comprises substantially the same graphics and textual information as web page 200 from FIG. 2A, except that the textual information of web page 201 is present to the user in German. German version web page 201 now displays language button 21 which offers the option to view web page 201 in English. However, other than the language change between web pages 200 (FIG. 2A) and 201 (FIG. 2B), there is no discernable change in the presentation of the website.

Turning now to the present invention, the next extension is preferably implemented by dynamically placing cultural awareness into the client application interface in such a way that the user's cultural profile would not only determine the person's location, but also identify the language and preferably even the dialect with which to interface or interact with the user. In a preferred embodiment of the inventive cultural specific user interface, the user ethnicity objects are entered into a cultural user profile. The system would then preferably interface with a client application for exchanging information concerning the user profile and the client application. The available graphical user interface (GUI) parameters of the client application would then preferably be analyzed. Based on the results of the analysis, selected ethnicity objects would preferably be communicated to the client application. Using these communicated objects, a GUI of the client application would preferably be configured according to the communicated ethnicity objects.

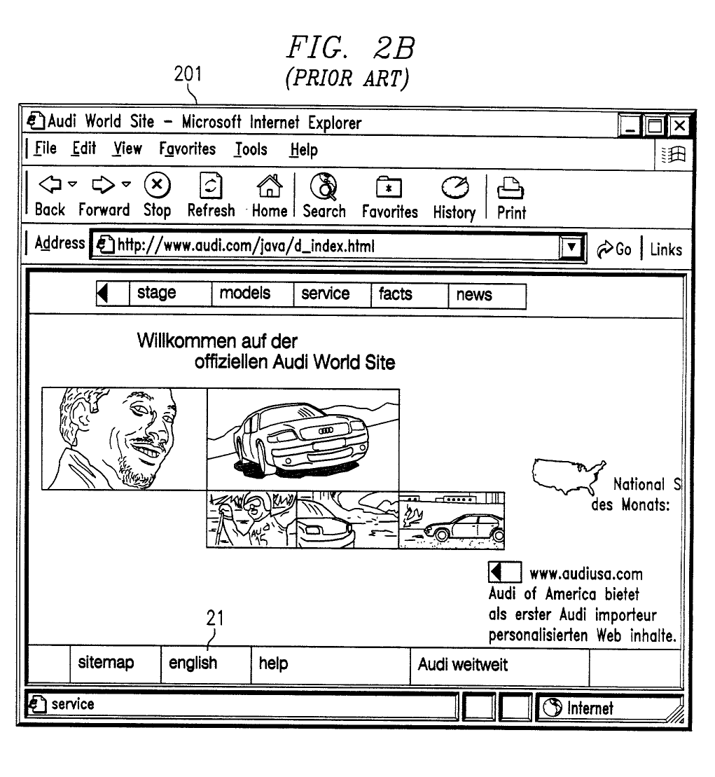

FIG. 3 illustrates such a preferred embodiment of the present invention configured for providing a culture-specific user interface. A user of computer 30 configured with an operating system and/or application according the preferred embodiment of the present invention begins the application by entering all relevant and user-ranked cultural information to build cultural profile 31. Cultural profile 31 would preferably comprise a list of languages preferred by the user and ranked in a hierarchical order of most-preferred to least-preferred. The user would then preferably enter his or her location as well as his or her ethnic origin and a religious preference. Using this information, cultural profile 31 is able to provide a depth of information regarding the user that can preferably be used with compatible client applications, such as other computer programs or Internet websites.

FIG. 3 is a block diagram that can be used to illustrate a scenario in which computer 30, with resident cultural profile 31, interacts with website 32. Website 32 typically comprises server 33 and database 34 for driving the presentation of website 32. In a first preferred embodiment of the present invention, website 32 is a compatible application. As computer 30 establishes a link to website 32, the information exchanged between the two preferably allows computer 30 to determine which interface attributes of website 32 are variable based on varying ethnicity objects contained in cultural profile 31. Computer 30 would also preferably be able to determine whether server 33 or database 34 store the necessary information to support any of the ethnicity objects of cultural profile 31. For example, website 32 may support Mandarin, but not Cantonese. Computer 30 would then preferably determine that the Mandarin cultural attribute of cultural profile 31 would be communicated to website 32 even though it is not the most-favored language of the user as listed in cultural profile 31.

After computer 30 determines the various cultural objects to communicate, those objects are preferably transmitted to website 32 for use in configuring the graphical user interface (GUI) presented to the user. Server 33 analyzes the cultural objects received from computer 30 and preferably retrieves the appropriate image and language objects from database 34 to render in the GUI for the user. The user is then preferably presented with a culture-specific website.

When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

In a second preferred embodiment of the present invention, website 32 is not necessarily compatible with the culture-specific protocol. However, website 32 is defined in an extensible language which may be mapped onto by information supplied by computer 30. In this embodiment of the present invention, computer 30 and website 32 preferably communicate to establish the link between them. In communicating the appropriate protocol signals, computer 30 preferably determines which of the graphical and textual objects of website 32 may be varied. Computer 30 will preferably store a database of culture-specific mapping objects which may be transmitted to website 32 for customizing the GUI to the user's ethnicity as defined in culture profile 31. Once computer 30 determines all of the variable parameters of website 32's GUI, the specific ethnicity mapping objects from computer 30 memory are preferably transmitted to website 32 and server 33 to render the customized GUI presented to the user.

It should be noted that the present invention is not limited to either one or the other of the embodiments referred to above. Alternative embodiments of the present invention may incorporate both the ability to interact with compatible websites or to push the culture-specific mapping objects onto the incompatible websites to create the culture-specific GUI presentation.

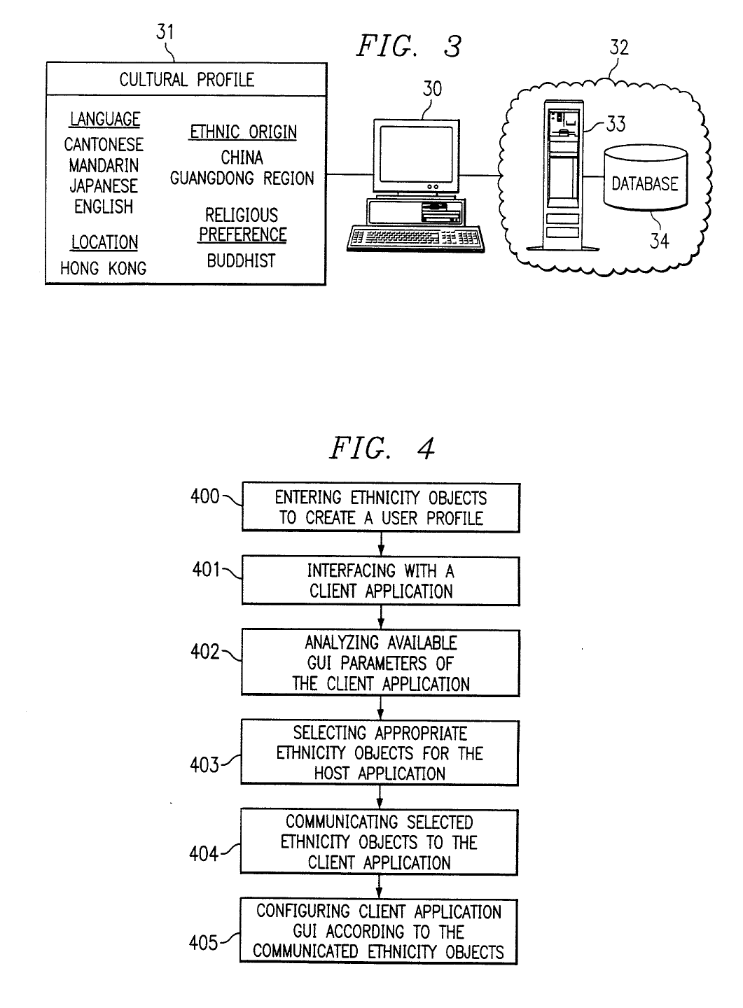

FIG. 4 is a flow chart showing the steps used in implementing a preferred embodiment of the present inventive cultural interface protocol. In step 400, a user cultural profile is created by preferably entering user ethnicity objects. The cultural interface protocol operates with other applications or websites. Therefore, the cultural protocol preferably interfaces with such a client application in step 401. The interfacing preferably provides information about the cultural protocol to the host as well as providing information about the host to the cultural protocol. In step 402, the inventive cultural protocol preferably analyzes the available GUI parameters of the client application to determine which of such parameters may be changed or varied according the ethnicity objects entered in step 400. In step 403, the cultural protocol preferably selects the appropriate ethnicity objects in the cultural profile for communicating to the client application. These selected ethnicity objects are then preferably communicated to the client application in step 404. In step 405, the client application preferably configures its GUI according to the particular ethnicity objects received from the cultural protocol. The client application will preferably obtain graphical and textual mapping objects from a related database or even from the cultural protocol's computer system to render the GUI. The resulting culture-specific GUI is preferably then presented to the user.

It should be noted that alternative embodiments of the present invention may be configured in many different ways. In one alternative embodiment, the inventive cultural protocol may come pre-installed on a computer or its operating system with a minimum basic user profile based on the destination address of the computer. Therefore, if a user chooses not to explore customizing the computer system, it will still preferably be able to present a certain degree of culture-specific information to the user. The user would preferably be capable of editing the default cultural parameters, thus creating a more deeply customized cultural interface.

It should further be noted that each embodiment of the present invention would preferably incorporate the ability to change or add to the ethnicity objects or languages preferred by the user.

Another alternative embodiment may come pre-installed on a computer without any cultural profile information or parameters entered. In such an embodiment, the cultural protocol could preferably prompt the user to enter any number of desired cultural attributes or parameters to fully take advantage of the inventive system.

In another embodiment, the inventive cultural protocol may preferably be sold or obtained as a separate application or utility to install on a pre-existing system. In such embodiments, the installation process may preferably prompt the user the enter appropriate ethnicity objects for allowing customized future interfaces.

What is claimed is:

1. A cultural interface protocol application for use on a computer system comprising:
a user profile stored in a memory of said computer system for defining cultural attributes;
a protocol interface for interfacing with a client application; and
an algorithm for determining ones of said cultural attributes to communicate to said client application, wherein said client application is configured according to said determined ones of said cultural attributes.

2. The cultural interface protocol application of claim 1 wherein said cultural attributes comprise at least one of:
user language preferences; and
a user ethnic origin.

3. The cultural interface protocol application of claim 2 wherein said user language preferences comprise:
a list of languages ranked according to user preference.

4. The cultural interface protocol application of claim 1 wherein said client application comprises one of:
a software application;
an Internet website; and
a data network.

5. The cultural interface protocol application of claim 2 wherein said configured client application is presented to said user in user language preference and graphical representation associated with said user ethic origin.

6. The cultural interface protocol application of claim 1 where said algorithm determines said ones of said cultural attributes using configuration parameters communicated from said client application.

7. The cultural interface protocol application of claim 5 further comprising a database of graphical interface objects used by said client application in rendering a graphical user interface of said client application, wherein said database is associated with said client application.

8. The cultural interface protocol application of claim 5 further comprising a database of graphical interface objects used by said client application in rendering a graphical user interface of said client application, wherein said database is associated with said user profile.

9. The cultural interface protocol application of claim 1 wherein said cultural interface protocol application is pre-installed on said computer system, said protocol application further comprising:
a user attribute interface for prompting said user to select desired ones of said cultural attributes from a predefined plurality of said cultural attributes.

10. The cultural interface protocol application of claim 1 further comprising:
an installer for installing said protocol application onto said computer system; and
an installation prompt for allowing said user to select desired ones of said cultural attributes from a predefined plurality of said cultural attributes.

11. A method for providing a cultural specific user interface comprising the steps of:
entering user ethnicity objects into a cultural user profile;
interfacing with a client application;
analyzing available graphical user interface (GUI) parameters of said client application;
communicating selected ethnicity objects to said client application responsive to said analyzing step; and
configuring a GUI of said client application according to said communicated ethnicity objects.

12. The method of claim 11 wherein said entering said user ethnicity objects step comprises at least one of the steps of:
entering a set of languages preferred by said user;
entering a cultural origin of said user; and
entering an originating country of said user.

13. The method of claim 11 wherein said analyzing step comprises the steps of:
receiving said available GUI parameters from said client application; and
determining said ones of said available GUI parameters variable according to said user ethnicity objects.

14. The method of claim 11 wherein said configuring step comprises the steps of:
receiving said communicated ethnicity objects;
adjusting said available GUI parameters according to said received ethnicity objects; and
rendering said GUI of said client application according to said adjusted available GUI parameters.

15. The method of claim 14 further comprising the step of:
retrieving graphical mapping objects from a database used in said rendering step.

16. A computer program product having a computer readable medium having computer program logic recorded thereon for providing a cultural specific user interface comprising:
means for obtaining user ethnicity objects;
means for creating a cultural user profile using said user ethnicity objects;
means for communicating with a client application;
means for determining variable graphical user interface (GUI) parameters of said client application;
means for selecting ethnicity objects from said cultural user profile responsive to said determining means; and
means for configuring said client application GUI according to said selected ethnicity objects.

17. The computer program product of claim 16 wherein said means for obtaining said user ethnicity objects comprises at least one of:
means for entering a set of languages preferred by said user;
means for entering a cultural origin of said user; and
means for entering an originating country of said user.

18. The computer program product of claim 16 wherein said means for determining comprises:
means for receiving indication from said client application of said variable GUI parameters;
means for comparing all of said user ethnicity objects to said variable GUI parameters; and
means for providing ones of said user ethnicity objects corresponding to said variable GUI parameters.

19. The computer program product of claim 16 wherein said means for configuring comprises:
means for communicating said selected ethnicity objects;
means for adjusting said variable GUI parameters according to said selected ethnicity objects; and
means for rendering said client application GUI according to said adjusted variable GUI parameters.

20. A language and cultural interface protocol application comprising:
a cultural profile of user specific cultural objects said objects comprising:
a list of languages preferred by a user; and
a cultural origin of said user;
an application interface for facilitating communication between said protocol and a client application;
a host interface analyzer for determining ones of graphical user interface (GUI) parameters of said client application which are variable according to ones of said user specific cultural objects; and
an object communicator for communicating selected ones of said user specific cultural objects to said client application wherein said client application varies said variable GUI parameters according to said communicated user specific cultural objects.
